(19) United States
(12) Patent Application Publication
(10) Pub. No.: US 2026/0328243 A1
(43) Pub. Date: Oct. 22, 2026

(54) PLASTIC-MOULDED HYBRID SPRING ROD AND BISTABLE MECHANISM COMPRISING SUCH A ROD

(71) Applicant: LATECOERE, Toulouse Occitaine (FR)

(72) Inventor: Fabian LOUVEL, Mons (FR)

(73) Assignee: LATECOERE, Toulouse Occitaine (FR)

(21) Appl. No.: 19/108,755

(22) PCT Filed: Sep. 1, 2023
(86) PCT No.: PCT/EP2023/074075

§ 371 Date: Mar. 5, 2025

(30) Foreign Application Priority Data
Sep. 9, 2022 (FR) FR2209050

(51) Int. Cl. E05F 1/08; B29C 45/14; B29L 31/06; F16C 7/06

(52) U.S. Cl. CPC F16C 7/06; B29L 2031/06; E05F 1/08; E05Y 2201/474; E05Y 2201/686; E05Y 2900/502

(57) ABSTRACT

A hybrid metal/plastic spring rod (1) having a guiding system (3) made up of a metal pin (4) and a plastic sliding body (5), a compression spring (2) and two plastic-moulded connecting members (6a, 6e). The connecting member (6a) of the sliding body (5) is moulded in one piece with this sliding body (5) of the guiding system (3) and the connecting members (6a, 6e) includes a shoulder (6c, 6g) perpendicular to the direction D of the metal pin, the compression spring (2) being positioned in contact with these shoulders (6c, 6g) and around the guiding system (3).

### CROSS REFERENCE TO RELATED APPLICATION

This application is a national stage entry of PCT/EP2023/074075 filed Sep. 1, 2023, under the International Convention and claiming priority over French Patent Application No. FR22209050 filed Sep. 9, 2022

### TECHNICAL FIELD OF THE INVENTION

The invention relates to a hybrid spring-loaded connecting rod equipped with a guiding system for this connecting rod, of which a part is molded in plastic material. Such a spring-loaded connecting rod is used in particular as a connecting part in opening/closing or locking mechanisms, in order to ensure that such a mechanism remains in place even in the event of a failure of the mechanism actuator.

The invention also relates to a mechanism with two positions of stability, known as bistable, of which at least one part is constituted by said hybrid spring-loaded connecting rod with part of its guiding system made of plastic material. In particular, vehicle doors-aircraft, trains, ships-are designed to be operated by such a bistable mechanism.

Particularly in the aeronautical field, aircraft doors are opening devices actuated by bistable mechanisms and adapted to occupy two stable positions-open or closed.

### PRIOR ART

Generally speaking, a connecting rod is a mechanical part with an elongated body and a joint at each end. The connecting rod is traditionally used to transmit and transform one movement into another, or to change its amplitude. The addition of a spring to the connecting rod body enables further transformations of the transmitted movement, the connecting rod body then consisting of two tubes fitted coaxially and adapted to slide into each other, forming the guiding system: such a spring-loaded connecting rod is then particularly suitable to ensure a bistable function in an opening/closing or a locking mechanism.

More specifically, such a mechanism drives a mechanical part that can move between two stable positions: when the part is in an intermediate position between these stable positions, it is then generally driven towards the nearest stable position by the spring-loaded connecting rod. In a first example, an aircraft door may comprise a bistable actuating mechanism for which the stable positions are extreme positions of the door, i.e. closed and open positions. Under the action of this bistable mechanism, when the door is in a half-open intermediate position, it is driven either towards its closed position or towards its open position.

According to another example also concerning aircraft doors, they can comprise a bistable locking mechanism equipped with a lever moving between a locking position and an unlocking position: when the lever is released between the locking position and the unlocking position, it switches to one or other of these positions depending on the position it is in when it is released.

Bistable mechanisms are commonly using gas springs. However, the force produced by a gas spring depends on the behavior of its gas, of which physical properties, and therefore compression behavior, vary with temperature. In aeronautical applications, aircraft are subjected to wide temperature variations during use-which can vary from 40 °C to +70 °C during a single flight. Furthermore, a gas spring also features a movable seal, which tightness is difficult to ensure throughout the aircraft's operating life.

To overcome the disadvantages of gas springs, metal spring-loaded connecting rods with a metal guiding system are used in bistable mechanisms: these spring-loaded connecting rods are more reliable because their mechanical properties vary very little over the operating temperature range, and they present no sealing problems. Such spring-loaded connecting rods with metal guides generically feature a joint at each end to limit the risk of wear with the other parts of the bistable mechanism to which these spherical plain bearings are attached.

In addition, the sliding of the push-in tubes of the connecting rod body produces undesirable friction, and metallic materials are susceptible to corrosion, both of which require coatings and/or surface treatments to ensure optimum operation of the spring-loaded connecting rod and the bistable mechanism. These drawbacks increase the complexity of manufacturing and installing the spring-loaded connecting rod with metal guiding system, as well as the weight of the bistable mechanism.

Patents CH692733, DE102012208224 and DE102011084066 disclose a spring-loaded connecting rod with metal and plastic parts. In the CH692733 patent, the connecting rod shaft and sliding body are made of metal, with a plastic liner interfacing between the shaft and sliding body. In patents DE102012208224 and DE102011084066, the pin is plastic and the sliding body is metal.

### SUMMARY OF THE INVENTION

In order to overcome the above-mentioned drawbacks of the state of the art, the main aim of the invention is to improve the manufacture and structure of a spring-loaded connecting rod, and to produce a mass-optimized bistable mechanism that is easier to install.

For this purpose, the invention provides a hybrid spring-loaded connecting rod with a guiding system of which a sliding body is molded in plastic material around a metal axis. Advantageously, this choice of material makes it possible to simplify the manufacture of the spring-loaded connecting rod, avoiding the application of surface treatments which prolong the manufacturing time and remain susceptible to degradation over time

More precisely, the object of the present invention is a spring-loaded connecting rod having two ends and having:
a guiding system for the connecting rod consisting of a metal pin and a body sliding on a zone along this metal pin;
a compression spring oriented in the direction of the metal axis of the guiding system, and
two connecting members each positioned at one of the ends of the spring-loaded connecting rod on the body and the metal pin respectively, the connecting members having a linking interface.

In this hybrid metal/plastic spring-loaded connecting rod, the sliding body and connecting members are molded in plastic, the connecting member being molded in one piece with the sliding body of the guiding system. In addition, the connecting members each have a shoulder perpendicular to the direction of the metal axis, the compression spring being positioned in contact with these shoulders and around the guiding system.

Advantageously, a hybrid spring-loaded connecting rod of which guiding system features a plastic body sliding along a metal pin reduces sliding friction, enabling the metal pin to be manufactured more quickly without the need for surface treatment to reduce friction. Furthermore, a metal/plastic interface is only slightly sensitive to temperature variations. Plastic molding of the guiding system body also simplifies manufacture of the hybrid spring-loaded connecting rod, as molding can be carried out quickly and at high production rates.

Advantageously too, the hybrid metal/plastic guiding system has a lower density and therefore a lower mass than an equivalent metal system, this lightening being particularly sought-after in the aeronautical world. Indeed, a gain in mass means either lower fuel consumption or the allocation of this gain in mass to another part of the aircraft.

According to preferred embodiments taken alone or in combination:
the metal pin has an clearance angle on the sliding zone;
the clearance angle is less than 5°;
the metal pin has a flange around which its connecting member is molded;
the body connecting member has a drainage hole and the pin connecting member has a positioning hole;
the linking interface between the connecting elements is open in a “U” shape;
the sliding body of the guiding system is molded and optimized in a lattice structure.

Advantageously, the clearance angle of the metal shaft allows a radial clearance that optimizes sliding with the plastic body.

Advantageously, the flange also enables the metal pin to be connected to the pin without the need for any fastening or fixing means.

The invention also relates to a process for manufacturing a hybrid spring-loaded connecting rod comprising a sliding body molded in plastic material around its metal axis.

The manufacturing process comprises the following steps;
machining the metal pin;
installing the metal pin in a tool comprising at least one injection mold;
positioning the metal axis on a positioning pin in the tool;
injecting plastic material into the mold through at least two injection nozzles;
removing the guiding system from the tool;
separating the plastic sliding body from the metal pin;
installing the spring between the shoulders, and
sliding the plastic sliding body along the metal axis.

Advantageously, this process enables all the components of the guiding system to be injected in a single operation, then the plastic body to be disassembled, so that a functional spring-loaded connecting rod can be rapidly obtained with minimum manufacturing and installation effort.

According to some preferred forms of implementation taken alone or in combination:
the machining of the metal axis comprises an angular clearance;
the flange is machined with the metal pin;
the mold comprises a dividing wall defining two molding volumes corresponding respectively to the sliding body and the pin connection member, each of these molding volumes being fed by an injection nozzle;

### DESCRIPTION OF THE FIGURES

Further features and advantages of the present invention will become apparent from the following detailed embodiment, without limiting the scope thereof, with reference to the appended figures, which show, respectively:

FIG. 1a shows an exploded view of a hybrid spring-loaded connecting rod;

FIG. 1b shows an assembled perspective view of a hybrid spring-loaded connecting rod;

FIG. 2 shows a cross-sectional view of the metal shaft illustrating the skinning process;

FIG. 3a, shows a perspective of the plastic body mould;

FIG. 3b shows a perspective view of the plastic body of the spring-loaded connecting rod after moulding;

FIG. 4a shows a cross-sectional view in plane A of the spring-loaded connecting rod guiding system at a first point during the phase of extracting the plastic body from the metal shaft;

FIG. 4b shows a cross-sectional view in plane A of the spring-loaded connecting rod guiding system at a second point during the phase of extracting the plastic body from the metal shaft; and

FIG. 4c shows a cross-sectional view in plane A of the spring-loaded connecting rod guiding system at a third point during the phase of extracting the plastic body from the metal shaft.

### DETAILED DESCRIPTION

In the figures, identical reference signs refer to the same element and to the corresponding passages in the description.

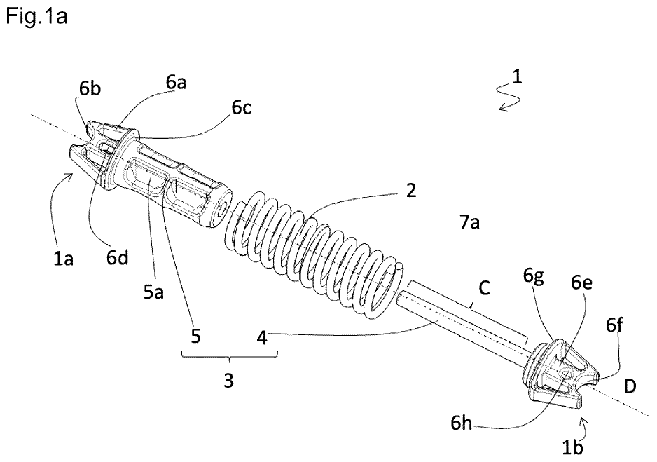

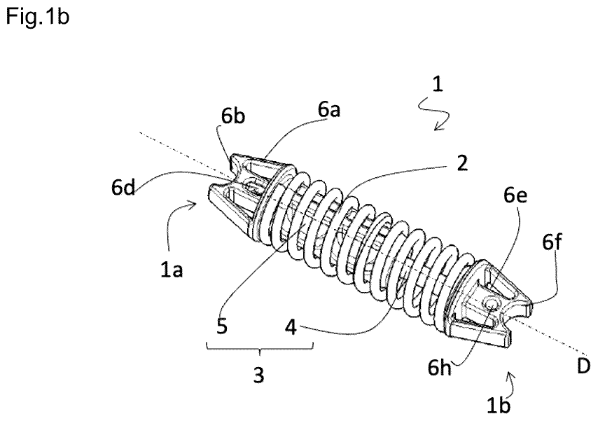

FIGS. 1a and 1b show a perspective view of a hybrid spring-loaded connecting rod 1, shown in an exploded view in FIG. 1a and in an assembled view in FIG. 1b. This spring-loaded connecting rod 1 is said to be hybrid in that one part of the connecting rod is metal and another part is plastic

The spring-loaded connecting rod 1 has two ends 1a and 1b and includes:
a connecting rod guiding system 3, consisting of a metal pin 4 and a plastic sliding body 5 extending over a zone C along this metal pin 4 ;
a compression spring 2 oriented in the direction D of the metal pin 4 of the guiding system 3, and
two connecting members 6a and 6e each positioned at one of the ends 1a, 1b of the spring-loaded connecting rod 1 on, respectively, the sliding body 5 and the metal axis 4, the connecting members 6a, 6b having a linking interface 6b, 6f.

In this example, the metal shaft is made of steel and the plastic sliding body is made of polyamide 66, more commonly known as “nylon”. However, any type of metal alloy (aluminum, titanium, inconel, etc.) and any type of plastic (polypropylene, polyethylene, polyamides, elastomers, with or without the addition of friction-optimized materials such as Teflon or others, etc.) can be used.

More specifically, these linking interfaces 6b, 6f form the connection at ends 1a and 1b between the hybrid spring-loaded connecting rod 1 and the other parts of the mechanism connected by this rod, an aircraft door opening/closing mechanism in the example shown. This connection is made by contact, with the linking interfaces 6b, 6f being open towards the mechanism parts in a U-shaped opening.

In addition, the connecting member 6a positioned on the sliding body 5 is advantageously molded in one piece with the sliding body 5, which is itself molded and mass-optimized according to a lattice structure, this optimization making it possible to limit the quantity of injected plastic and thus reduce molding manufacturing time Furthermore, as the sliding body 5 typically has a cavity 5a in which the metal pin 4 slides, undesirable fluids from the environment can spill into it, causing the hybrid spring-loaded connecting rod 1 to malfunction. To evacuate these fluids, connecting member 6a advantageously features a drainage hole 6d. The connecting member 6d at the end of the metal pin 4 also has an opening in the form, in this example, of a positioning hole 6h resulting from the manufacturing process explained below.

The shoulders 6c and 6g on the respective connecting members 6a and 6e are visible in the exploded view in FIG. 1a. These shoulders 6c, 6g are positioned perpendicular to the direction D of the metal axis 4, the compression spring 2 being in contact with the shoulders 6c, 6g and around the guiding system 3, as shown in FIG. 1b.

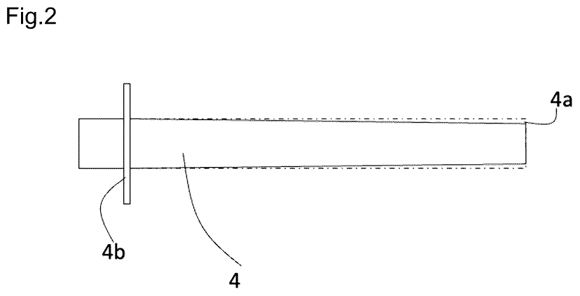

FIG. 2 illustrates the metal pin 4. This metal pin 4 preferably has an clearance angle 4a over the sliding zone C, a clearance angle of 2 degrees in the example shown, preferably less than 5 degrees. This allows the sliding body 5 to slide more smoothly along the metal axis 4, reducing the risk of jamming the guiding system 3.

In addition, metal pin 4 has a flange 4b, arranged perpendicular to axis D, around which its connecting member 6e is molded. The flange 4b eliminates the need for any connecting means between the metal pin 4 and the connecting member 6e. This flange can be machined directly at the same time as the metal pin 4, or can be an independent part attached to this pin.

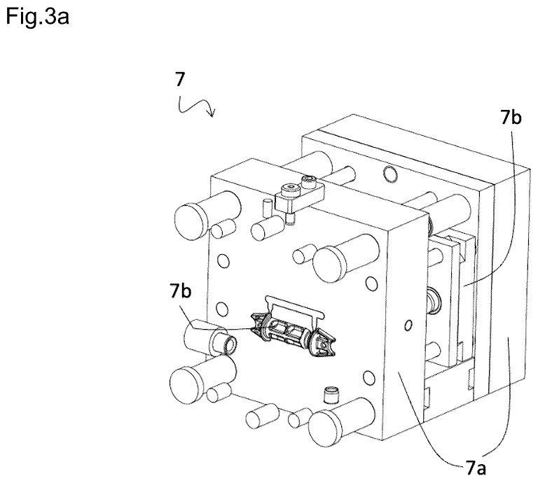

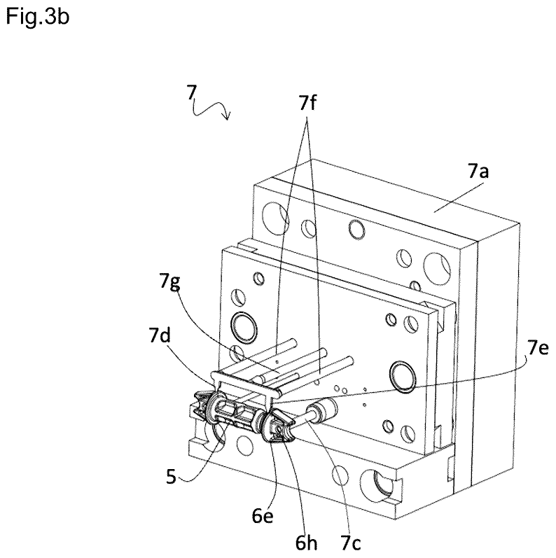

FIG. 3a shows the tooling 7 used to mold the sliding body 5 of the guiding system 3 and the connecting members 6a, 6e (see FIG. 1a) of the hybrid spring-loaded connecting rod 1 from plastic. FIG. 3b also shows in greater detail how the guiding system 3 is removed from the tooling 7 during demolding. This tooling 7 comprises a press 7a for conveying plastic material into the mold 7b by means of injection nozzles 7d, 7e via conveying pins 7f. Nozzles 7d, 7e are positioned and installed on extraction rod 7g. This extraction rod 7g pushes on the plastic material and ejects the guiding system 3 from tooling 7.

In operation, the hybrid spring-loaded connecting rod 1 is manufactured by injecting plastic around the metal pin in the following steps:
machining the metal pin 4;
installation of metal pin 4 in tooling 7 comprising injection mold 7a;
positioning of metal pin 4 on positioning rod 7c in tooling 7;
injection of plastic material into mold 7b through injection nozzles 7d, 7e;
extraction of guiding system 3 from tooling 7;
separating the sliding plastic body 5 from the metal pin 4;
installation of spring 2 between shoulders 6c and 6g, and
sliding the plastic sliding body 5 along the metal pin 4.

The metal pin 4 is traditionally produced by turning, which enables the flange 4b and the angular clearance 4a to be machined at the same time. Metal pin 4 can also be produced by extrusion, with flange 4b manufactured separately and then assembled to metal pin 4 by welding or fastening.

The metal pin 4 is then installed in the mold 7b, abutting the positioning rod 7c. The injected plastic therefore surrounds the pin 7c, and when the guiding system 3 is removed from the tool, the space occupied by the pin 7c is empty, creating the positioning hole 6h (see FIG. 1b). Other methods of positioning the metal pin 4 in the mold are possible, in particular by fixing the metal pin 4 in the section that will not be covered with plastic. Alternatively, the pin 7c can be removed after positioning and securing the metal pin 4. In these embodiments, no positioning holes are made, as the plastic is injected into the entire volume of the connecting member 6e.

Tooling 7 here comprises a single mold 7a for producing, on the one hand, the sliding body 5 with the connecting member 6a and, on the other hand, the connecting member 6e integral with the metal pin 4 around the flange 4b. The 7a mold is therefore used to mold two distinct parts, the sliding body 5 and the metal pin 4 with their respective connecting members, and features a dividing wall which defines and isolates two molding volumes corresponding respectively to the sliding body 5 and the connecting member 6e of the metal pin 4. Each of these molding volumes is fed by its own injection nozzle 7d, 7e as the dividing wall blocks the passage of injected plastic from one molding volume to the other. Alternatively, tooling 7 can comprise two juxtaposed molds, each fed by an independent nozzle.

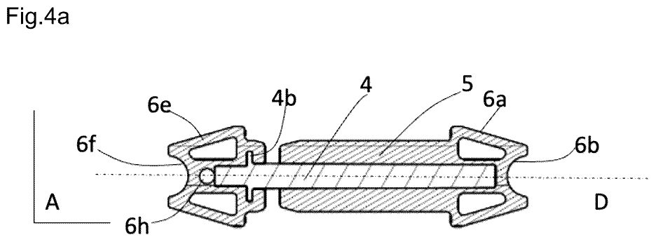

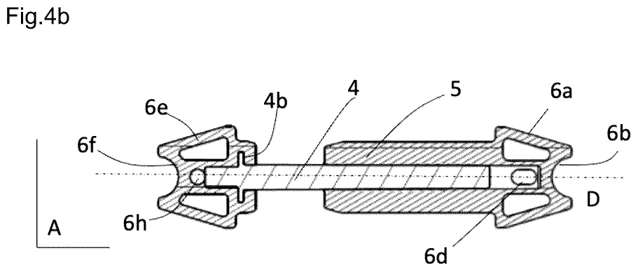

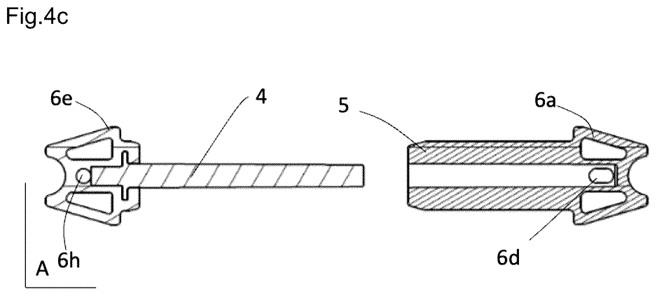

FIG. 4a, FIG. 4b and FIG. 4c show cross-sectional views of the guiding system 3 in a longitudinal plane A of the hybrid spring-loaded connecting rod 1 at three successive instants during the extraction phase by separating the sliding body 5 from the metal pin 4. At the start of this phase with reference to FIG. 4a, the sliding body 5 and the metal pin 4 are assembled following the injection of plastic into the mold 7b.

The metal pin 4 is then progressively extracted from the sliding body 5 (FIG. 4b), this extraction being facilitated by the clearance angle 4a. The mold 7b directly incorporates the drainage hole 6d: the drainage hole 6d, which passes through the sliding body 5 on both sides, frees itself when the pin is extracted. FIG. 4c shows the complete separation of the metal pin 4 from the sliding body 5. The cross-sectional view of these figures shows the flange 4b and the connecting member 6e molded around this flange 4b. Alternatively, if the mold 7b does not incorporate the drainage hole, a drainage hole drilling step is performed.

1. A hybrid metal/plastic spring-loaded connecting rod (1) having two ends (1a, 1b) and comprising:
a connecting rod guiding system (3) including a metal pin (4) and a body (5) sliding over a zone C along the metal pin (4);
a compression spring (2) oriented in the direction D of the metal pin (4) of the guiding system (3), and
two connecting members (6a, 6e) each positioned at one of the ends (1a, 1b) of the spring-loaded connecting rod (1) on the sliding body (5) and the metal pin (4) respectively, the connecting members (6a, 6e) having a linking interface (6b, 6f);
wherein the sliding body (5) and the connecting members (6a, 6e) are molded from plastic material, the connecting member (6a) of the sliding body (5) being molded in one piece with the sliding body (5) of the guiding system (3), and wherein the connecting members (6a, 6e) each comprise a shoulder (6c, 6g) perpendicular to the direction D of the metal axis (4), the compression spring being positioned in contact with these shoulders (6c, 6g) and around the guiding system (3).

2. The hybrid spring-loaded connecting rod (1) according to claim 1, wherein the metal pin (4) has clearance angle (4a) over the sliding zone C.

3. The hybrid spring-loaded connecting rod (1) according to claim 2, wherein the clearance angle (4a) is less than 5°.

4. The hybrid spring-loaded connecting rod (1) according to claim 1, wherein the metal pin (4) has a flange (4b) around which the connecting member (6e) is molded.

5. The hybrid spring-loaded connecting rod (1) according to claim 1, wherein the connecting member (6a) of the sliding body (5) has a drainage hole (6d) and the connecting member (6e) of the metal pin (4) has a positioning hole (6h).

6. The hybrid spring-loaded connecting rod (1) according to claim 1, wherein the linking interface (6b, 6f) of the connecting members (6a, 6e) is open in a “U” shape.

7. The hybrid spring-loaded connecting rod (1) according to claim 1 , wherein the sliding body (5) of the guiding system (3) is molded and optimized according to a lattice structure.

8. A manufacturing process for a hybrid spring-loaded connecting rod (1) comprising a sliding body (5) molded in plastic material around its metal axis (4) according to any of the preceding claims, wherein manufacturing takes place according to the following steps:
machining the metal pin (4);
installing the metal axis (4) in a tool (7) comprising at least one injection mold (7b);
positioning the metal pin (4) on a positioning rod (7c) in the tooling (7);
injecting plastic material into the mold (7b) through at least two injection nozzles (7d, 7e);
extracting the guiding system (3) from the tooling (7);
separating the plastic sliding body (3) from the metal pin (4);
installing the spring (2) between the shoulders (6c, 6g); and
sliding the plastic sliding body (5) along the metal shaft (4).

9. The manufacturing process according to claim 8, in which the step of machining the metal axis (4) comprises a step of angular clearance of less than 5 degrees.

10. The m manufacturing process according to claim 8 wherein the step of machining the metal pin (4) comprises a step of machining the flange (4b).

11. The manufacturing process according to claim 8, wherein the mold (7b) comprises a dividing wall defining two molding volumes corresponding respectively to the sliding body (5) and to the connecting member (6e) of the metal pin (4), each of these molding volumes being fed by an injection nozzle (7d, 7e).
